(19) United States
(12) Patent Application Publication
(10) Pub. No.: US 2014/0056160 A1
(43) Pub. Date: Feb. 27, 2014

(54) COMMUNICATION DEVICE AND COMMUNICATION METHOD

(71) Applicant: Sony Corporation, Tokyo (JP)

(72) Inventors: Kunihiko Miyake, Kanagawa (JP); Kimiya Kato, Tokyo (JP)

(73) Assignee: SONY CORPORATION, Tokyo (JP)

(21) Appl. No.: 13/961,250

(22) Filed: Aug. 7, 2013

(30) Foreign Application Priority Data
Aug. 21, 2012 (JP) 2012-182452

(51) Int. Cl. H04W 24/00

(52) U.S. Cl. CPC H04W 24/00
USPC 370/252

(57) ABSTRACT

A communication device includes a signal strength check unit that checks the signal strength of a radio signal using a broad radio frequency range, a communication target detection unit that detects a communication target in descending order of the signal strength of the radio signal, which is checked by the signal strength check unit, for each frequency band that is included in the broad radio frequency range.

### BACKGROUND

The present disclosure relates to a communication device and a communication method, and in particular, to a communication device and a communication method that can speed up detection of a communication target of a wireless LAN.

With the spread of multi-function mobile phones that are called smartphones, laptop personal computers (PCs), etc., the opportunities for using a wireless LAN have increased. As a result, it takes a long time to connect such mobile phones, PCs, etc. to a wireless LAN, so that there are some cases in which such mobile phones, PCs, etc. may not be used in the field immediately.

On the other hand, for example, in Japanese Unexamined Patent Application Publication No. 2007-306510, a technology that takes advantage of a connection record has been proposed, and in Japanese Unexamined Patent Application Publication No. 2008-118538, a technology that stores location information has been proposed.

### SUMMARY

In the related art, there is a device that is mainly compatible with a 2.4 GHz range as a function of the wireless LAN, and recently, there has been an increase in the number of devices that are compatible with both the 2.4 GHz range and the 5 GHz range. In a case of the device that is compatible with both the 2.4 GHz range and the 5 GHz range, there are a large number of radio channels, and when all of the radio channels are simply scanned in ascending order, it takes a long time to scan channels, so that it also undesirably takes a long time to establish connection with a target communication party.

In the future, it is conceivable that the opportunities for using a wireless LAN connection device further increase, so that it is expected that the number of radio channels that can be used also increases. Therefore, it is conceivable that a technology for improving a method of scanning channels and a technology for reducing in a radio connection establishment time, which is associated with the improvement of the method are important.

In view of such circumstances, in the present disclosure, detection of a communication target of a wireless LAN can be speeded up.

According to an embodiment of the present disclosure, there is provided a communication device that includes a signal strength check unit that checks the signal strength of a radio signal using a broad radio frequency range, a communication target detection unit that detects a communication target in descending order of the signal strength of the radio signal, which is checked by the signal strength check unit, for each frequency band that is included in the broad radio frequency range.

The signal strength check unit can check the signal strength of the radio signal using the broad radio frequency range and check the signal strength of the radio signal using a radio frequency range that is narrower than the broad radio frequency range, in the broad radio frequency range in descending order of checked signal strength of the radio signal, and the communication target detection unit can detect the communication target for each band that is included in the narrower radio frequency range in descending order of the signal strength of the radio signal, which is checked by the signal strength check unit.

The communication target detection unit can detect the communication target from a frequency band that is the center of the broad radio frequency range, out of frequency bands that are included in the broad radio frequency range.

The communication device is constituted by a module.

The communication device is constituted by an integrated device.

The communication device can further include a display control unit that controls display of the communication target that is detected by the communication target detection unit each time the communication target detection unit terminates the detection of the communication target for each of the frequency bands.

The communication target is an access point.

A communication method according to an embodiment of the present disclosure includes checking the signal strength of a radio signal using a broad radio frequency range by a communication device, and detecting a communication target in descending order of checked signal strength of the radio signal, for each frequency band that is included in the broad radio frequency range.

According to an embodiment of the present disclosure, the signal strength of a radio signal is checked using a broad radio frequency range. In addition, a communication target is detected for each frequency band that is included in the broad radio frequency range in order of checked signal strength of the radio signal.

According to the present disclosure, detection of a communication target of a wireless LAN can be speeded up.

### BRIEF DESCRIPTION OF THE DRAWINGS

FIG. 1 is a diagram illustrating a configuration example of a communication system according to an embodiment of the present technology;

FIG. 2 is a diagram illustrating frequency bands that are used for a wireless LAN;

FIG. 3 is a diagram illustrating an access point searching procedure in a case of a 2.4 GHz range;

FIG. 4 is a diagram illustrating an access point searching procedure in a case of a 5 GHz range;

FIG. 5 is a flowchart illustrating the access point searching processing in a case of the 2.4 GHz range;

FIG. 6 is a flowchart illustrating the access point searching processing in the case of 5 GHz range;

FIG. 7 is a diagram illustrating another configuration example of the communication system according to the embodiment of the present technology;

FIG. 8 is a diagram illustrating another configuration example of the communication system according to the embodiment of the present technology;

FIG. 9 is a diagram illustrating another configuration example according to the embodiment of the present technology; and

FIG. 10 is a block diagram illustrating a configuration example of a computer.

### DETAILED DESCRIPTION OF EMBODIMENTS

The embodiments for carrying out the present disclosure are described below.

### [Configuration of a Communication System According to an Embodiment the Present Technology]

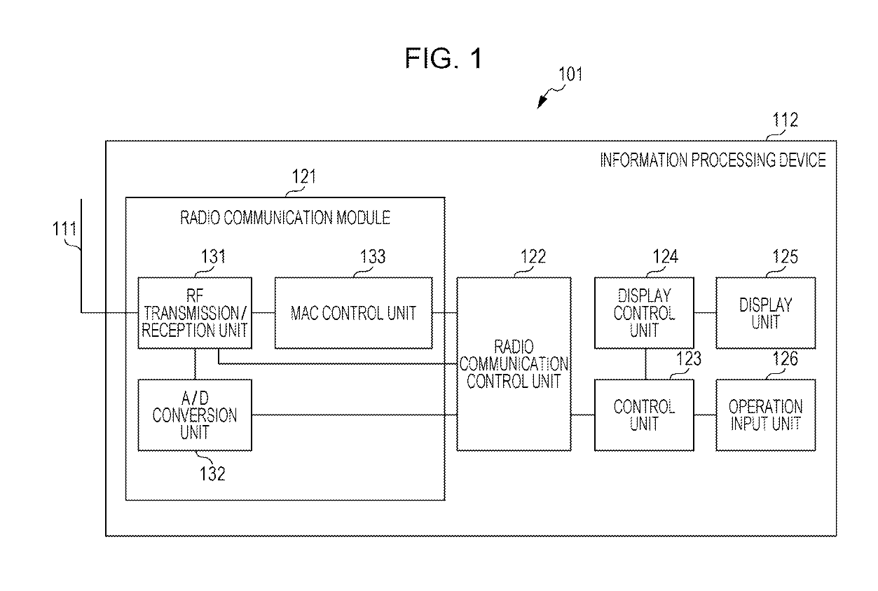

FIG. 1 is a diagram illustrating a configuration example of a communication system according to an embodiment of the present technology.

In the example of FIG. 1, a communication system 101 includes an antenna 111 and an information processing device 112.

The antenna 111 is provided in the information processing device 112, and performs transmission and reception of a radio signal between a radio access point that is not illustrated and the information processing device 112.

The information processing device 112 includes, for example, a multi-function mobile phone such as a laptop personal computer, a tablet terminal, or a smartphone. The information processing device 112 includes a radio communication module 121, a radio communication control unit 122, a control unit 123, a display control unit 124, a display unit 125, and an operation input unit 126.

The radio communication module 121 is a module that is built into the information processing device 112 and used to perform radio communication with another information processing device through a radio access point. The radio communication module 121 determines a radio access point that is not illustrated as a communication target and performs transmission and reception of the radio signal through the antenna 111, under the control of the radio communication control unit 122.

The radio communication module 121 includes a radio frequency (RF) transmission/reception unit 131, an analog/digital (A/D) conversion unit 132, and a media access control (MAC) control unit 133.

The RF transmission/reception unit 131 performs transmission and reception of the radio signal in a frequency range (width) that is set by the radio communication control unit 122, under the control of the radio communication control unit 122. When the RF transmission/reception unit 131 receives the radio signal, the RF transmission/reception unit 131 supplies the received radio signal to the A/D conversion unit 132.

The A/D conversion unit 132 converts the analogue radio signal that is supplied from the RF transmission/reception unit 131, into a digital signal, and supplies the converted digital signal to the radio communication control unit 122.

The MAC control unit 133 performs active scan on each frequency band, which is a channel of the frequency range that is set by the radio communication control unit 122 (hereinafter simply referred to as channel), through the RF transmission/reception unit 131. That is, the MAC control unit 133 transmits a probe request through the RF transmission/reception unit 131, and a radio access point, which has received the probe request, sends back information regarding the access point. When the radio access point is detected by the active scan, the MAC control unit 133 receives information regarding the access point through the RF transmission/reception unit 131 and supplies the information to the radio communication control unit 122.

The radio communication control unit 122 sets the frequency range of the radio communication module 121, which is constituted by a plurality of frequency bands, and checks the presence or absence of a radio signal and the signal strength of the radio signal in the set frequency range, using the RF transmission/reception unit 131. In the radio communication module 121, first, the broadest frequency range that can be used in a standard is set, and check processing of the presence or absence of a radio signal and the signal strength of the radio signal is executed. When there is a frequency range that is narrower than the above-described frequency range, the second broadest frequency range is set, and check processing of the presence or absence of a radio signal and the signal strength of the radio signal is executed.

When there is a radio signal in the set frequency range, the radio signal is received by the RF transmission/reception unit 131, converted into a digital signal by the A/D conversion unit 132, and supplied to the radio communication control unit 122. The radio communication control unit 122 checks the presence or absence of a radio signal and the signal strength of the radio signal in the corresponding frequency range using the digital signal that is supplied from the A/D conversion unit 132.

The radio communication control unit 122 causes the MAC control unit 133 to start the active scan from each channel of a frequency range having the highest signal strength, and supplies information regarding access points, which are obtained as a result, to the control unit 123.

The control unit 123 supplies the information regarding the access points that are supplied from the radio communication control unit 122 in the set frequency range, to the display control unit 124, and causes the display control unit 124 to perform display control of a list of the access points. In addition, the control unit 123 supplies information regarding the access points that correspond to an operation of the operation input unit 126 by a user, to the radio communication control unit 122.

The display control unit 124 causes the display unit 125 to display the list of the access points using the information regarding the access points, which is supplied from the radio communication control unit 122, under the control of the control unit 123.

The display unit 125 is constituted by a liquid crystal display (LCD), etc., and displays the list of the access points, which is supplied from the display control unit 124. The operation input unit 126 is constituted by a touch-screen, a button, etc., and supplies a signal that corresponds to an operation of the user to the control unit 123.

### [Frequency Bands and a Frequency Range]

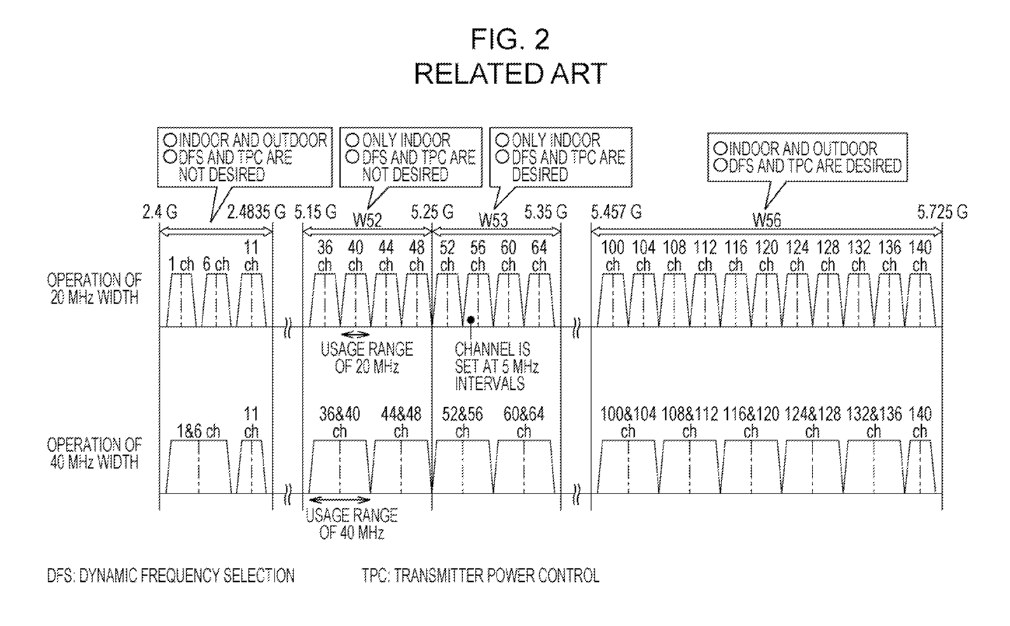

FIG. 2 is a diagram illustrating frequency bands and a frequency range (frequency bandwidth) that are used in a wireless LAN.

In the IEEE802.11n standard, a 2.4 GHz range corresponds to 2.4 GHz to 2.4835 GHz, and corresponds to a frequency range that can be used both indoors and outdoors without dynamic frequency selection (DFS) and transmitter power control (TPC).

In the 2.4 GHz range, when a 20 MHz band operation is performed without interference of radio waves, each employed 20 MHz band is used while using 1ch, 6ch, and 11ch as the centers, out of 1ch to 13ch. The channel is set at 5 MHz intervals. In addition, in the 2.4 GHz range, when a 40 MHz band operation is performed without interference of radio waves, for example, channels are arranged so that “1+6ch” corresponds to an employed 40 MHz band and 11ch is set as the center for an employed 20 MHz band, out of 1ch to 13ch.

On the other hand, in the IEEE802.11n standard, in a 5 GHz range, a W52 type that corresponds to a frequency range between 5.15 GHz to 5.25 GHz, a W53 type that corresponds to a frequency range between 5.25 GHz to 5.35 GHz, and a W56 type that corresponds to a frequency range between 5.457 GHz to 5.725 GHz can be used. A frequency range between 5.35 GHz to 5.457 GHz is not currently used.

The W52 type does not employ DFS and TPC and corresponds to a frequency range that can be used indoors. In the W52 type, the 20 MHz width operation is performed in each of the employed 20 MHz bands using 36ch, 40ch, 44ch, and 48ch as the centers. In addition, in the W52 type, the 40 MHz width operation is performed in each of the employed 40 MHz bands having “36+40ch” and “44+48ch” as the centers.

The W53 type employs DFS and TPC and corresponds to a frequency range that can be used indoors. In the W53 type, the 20 MHz width operation is performed in each of the employed 20 MHz bands using a 52ch, a 56ch, a 60ch, and a 64ch as the center. In addition, in the W53 type, the 40 MHz width operation is performed in each of the employed 40 MHz bands having “52+56ch” and “60+64ch” as the centers.

The W56 type employs DFS and TPC and corresponds to a frequency range that can be used both indoors and outdoors. In the W56 type, the 20 MHz width operation is performed in each of the employed 20 MHz bands having 100ch, 104ch, 108ch, 112ch, 116ch, 120ch, 124ch, 128ch, 132ch, 136ch, and 140ch as the centers. In addition, in the W56 type, the 40 MHz width operation is performed in each of the employed 40 MHz bands having “100+104ch”, “108+112ch”, “116+120ch”, “124+128ch”, “132+136ch”, and 140ch as the centers.

The W53 type and the W56 type employ DFS and TPC in Japan and Europe, and employ DFS in the U.S. In addition, in the W56 type, 120ch, 124ch, and 128ch can be used in Japan and Europe, and are not used in the U.S.

As described above, with the spread of the IEEE802.11n standard, the frequency range of 40 MHz bands has been able to be used in addition to the system of the related art using the frequency range of 20 MHz bands in the 802.11a/b/g standard.

In the present technology, as described later, speeding up of searches for a wireless LAN access point that is a communication target is achieved by using the frequency range of 40 MHz bands and the frequency range of 20 MHz band.

### [Example of the 2.4 GHz Range]

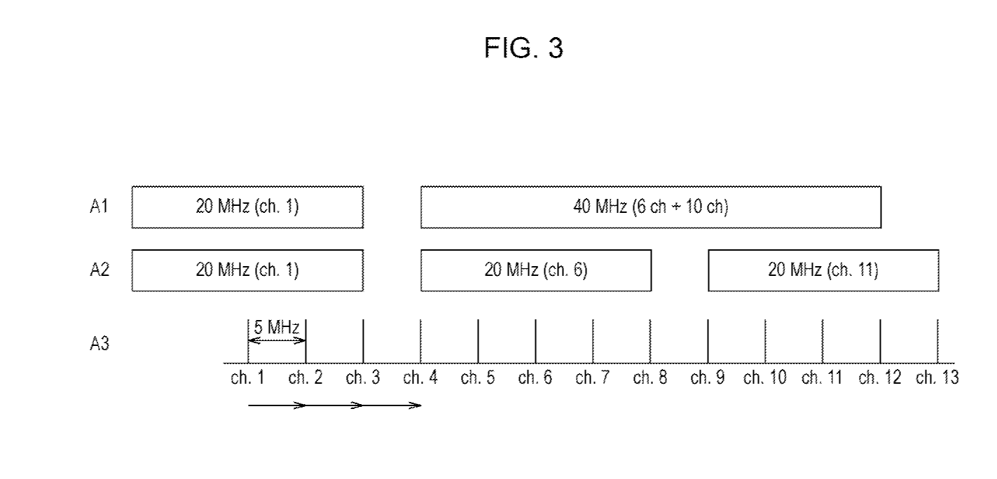

In the example of FIG. 3, a searching procedure for searching for a wireless LAN access point in the case of the 2.4 GHz range, which is performed by the communication system 101 is illustrated.

As described in A1, in the case of the 2.4 GHz range, first, the radio communication control unit 122 sets a mode of a frequency band of the radio communication module 121 to a 20 MHz mode (20 MHz band (ch.1)) in which ch.1 is set as the center. That is, in the 20 MHz mode (20 MHz band (ch.1)) in which ch.1 is set as the center, the 20 MHz band in which ch.1 is set as the center is continuously used. The radio communication control unit 122 checks the presence or absence of a radio signal and the signal strength of the radio signal in the set frequency band of 20 MHz (ch.1), using the RF transmission/reception unit 131. As a result, the presence or absence of the radio signal and the signal strength of the radio signal are checked in the frequency range of ch.1 to ch.3.

In addition, the radio communication control unit 122 sets the frequency range band of the radio communication module 121 to a 40 MHz mode in which ch.6 and ch.10 are set as the centers (40 MHz band (ch.6+ch.10)). That is, in the 40 MHz mode in which ch.6 and ch.10 are set as the centers (40 MHz band (ch.6+ch.10)), a 40 MHz band in which ch.6 and ch.10 are set as the centers is continuously used.

As described in A2, in the case of the 20 MHz mode, there are unused bands (guard bands) between the frequency range in which ch.1 is set as the center, the frequency range in which ch.6 is set as the center, and the frequency range in which ch.11 is set as the center so that the interference does not occur. On the other hand, when the 40 MHz band is continuously used in the 40 MHz mode, as illustrated in A1, the 40 MHz band is continuously used so that the unused bands between the frequency band in which ch.6 is set as the center and the frequency band in which ch.11 is set as the center is removed. As a result, the center frequency band corresponds to ch.10 so as to be shifted by one channel. Therefore, in the case of the 40 MHz mode, using ch.8 that is obtained by dividing “ch.6+ch.10” by 2, as the center, ch.4 to ch.12 are occupied.

The radio communication control unit 122 checks the presence or absence of a radio signal and the signal strength of the radio signal in the set 40 MHz band (ch.6+ch.10) using the RF transmission/reception unit 131. As a result, the presence or absence of the radio signal and the signal strength of the radio signal are checked in the frequency range of ch.4 to ch.12.

Here, the 20 MHz mode in which ch.1 is set as the center is used instead of the 40 MHz mode in which ch.1 is set as the center because ch.1 is typically used as an access point presently.

After that, as illustrated in A2, the radio communication control unit 122 sets the mode of the frequency band of the radio communication module 121 to a 20 MHz mode in which ch.6 is set as the center (20 MHz band (ch.6)). That is, in the 20 MHz mode in which ch.6 is set as the center (20 MHz band (ch.6)), the 20 MHz band in which ch.6 is set as the center is continuously used. The radio communication control unit 122 checks the presence or absence of a radio signal and the signal strength of the radio signal in the set 20 MHz band (ch.6) using the RF transmission/reception unit 131. As a result, the presence or absence of the radio signal and the signal strength of the radio signal are checked in the frequency range of ch.4 to ch.8.

In addition, the radio communication control unit 122 sets the mode of the frequency band of the radio communication module 121 to a 20 MHz mode in which ch.11 is set as the center (20 MHz band (ch.11)). In the 20 MHz mode in which ch.11 is set as the center (20 MHz band (ch.11)), the 20 MHz band in which ch.11 is set as the center is continuously used. The radio communication control unit 122 checks the presence or absence of a radio signal and the signal strength of the radio signal using the RF transmission/reception unit 131. As a result, the presence or absence of a radio signal and the signal strength of the radio signal are checked in the frequency range of ch.9 to ch.13.

Here, the radio communication control unit 122 compares the signal strength in the 20 MHz band (ch.1), the signal strength in the 20 MHz band (ch.6), with the signal strength in the 20 MHz band (ch.11), and starts the active scan on each channel of the mode having the highest signal strength.

For example, when the signal strength in the 20 MHz band (ch.1) is the highest as illustrated in A3, the active scan is performed on each of ch.1, ch.2, and ch.3 in the 20 MHz band (ch.1). As a result of the active scan, an access point is detected and presented to the user. When the detected access point is not selected by the user, the active scan is performed on each channel in a frequency range having the highest signal strength next to that of the 20 MHz band (ch.1).

After A1, the signal strength of the 20 MHz band (ch.1) and the signal strength of the 40 MHz band (ch.6+10) are compared to each other, and when the signal strength of the 20 MHz band (ch.1) is higher, the processing of A2 is skipped, and the active scan may be performed as illustrated in A3.

For example, when the frequency range having the highest signal strength next to that of the 20 MHz band (ch.1) corresponds to the 20 MHz band (ch.6), as illustrated in A3, the active scan is performed on each ch.6, ch.5, ch.7, ch.4, and ch.8 in the 20 MHz band (ch.6). As a result of the active scan, an access point is detected and presented to the user. When the detected access point is not selected by the user, the active scan is performed on each channel in a frequency band having the highest signal strength next to that of the 20 MHz band (ch.6).

For example, when the frequency range having the highest signal strength next to that of the 20 MHz band (ch.6) corresponds to the 20 MHz band (ch.11), as illustrated in A3, the active scan is performed on each of ch.11, ch.10, ch.12, ch.9, and ch.13 in the frequency range of the 20 MHz band (ch.11). As a result of the active scan, an access point is detected and presented to the user. When the detected access point is not selected by the user, the processing ends.

As described above, in each of the frequency ranges, the active scan is started from the frequency band that is set as the center (ch.1, ch.6, and ch.11), the order is not limited.

### [Example of 5 GHz Range]

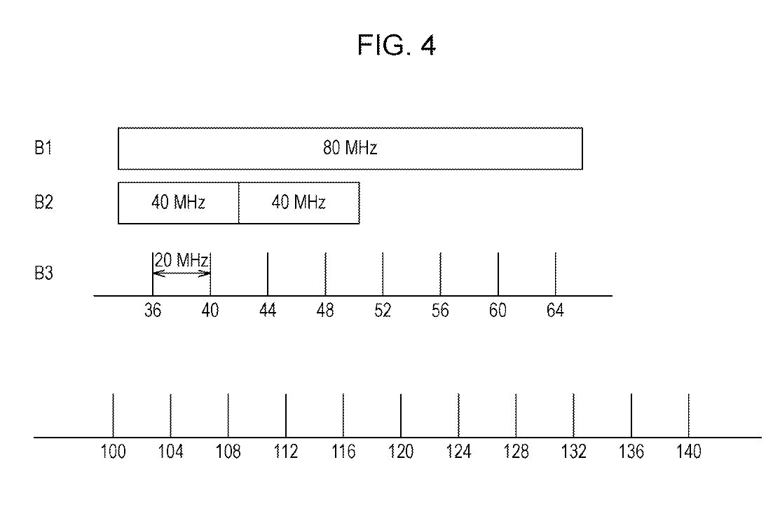

In the example of FIG. 4, a searching procedure for searching for a wireless LAN access point in the case of 5 GHz, which is performed by the communication system 101 is illustrated. In the 802.11ac standard, a 80 MHz mode can be used. Thus, when the 802.11ac standard can be used, as illustrated in B1, in the case of 5 GHz, the mode of the frequency band of the radio communication module 121 is set to the 80 MHz mode, and the searching procedure that is similar to that of the 2.4 GHz mode can be performed.

In the case of the 5 GHz, as illustrated in B2, first, the radio communication control unit 122 sets the mode of the frequency band of the radio communication module 121 to a 40 MHz mode in which ch.36 and ch.40 is set as the center (40 MHz band (ch.36+40)). That is, in the 40 MHz mode in which ch.36 and ch.40 are set as the center (40 MHz band (ch.36+40)), the 40 MHz band in which ch.36 and ch.40 are set as the center is continuously used. The radio communication control unit 122 checks the presence or absence of a radio signal and the signal strength of the radio signal in the set 40 MHz band (ch.36+40) using the RF transmission/reception unit 131.

In addition, the radio communication control unit 122 sets the mode of the frequency band of the radio communication module 121 to a 40 MHz mode in which ch.44 and ch.48 are set as the center (40 MHz band (ch.44+48)). That is, in the 40 MHz mode in which ch.44 and ch.48 are set as the center (40 MHz band (ch.44+48)), the 40 MHz band in which ch.44 and ch.48 are set as the center is continuously used. The radio communication control unit 122 checks the presence or absence of a radio signal and the signal strength of the radio signal in the set 40 MHz band (ch.44&ch.48) using the RF transmission/reception unit 131.

In ch.52 and subsequent channels, similarly, the mode of the frequency band of the radio communication module 121 is set at the 40 MHz mode in which the 40 MHz band in which the corresponding frequency width is set as the center is continuously used, and check processing of the presence or absence of a radio signal and the signal strength of the radio signal in the mode is executed. After that, the radio communication control unit 122 compares the signal strengths of the 40 MHz band (ch.36+40), the signal strength of the 40 MHz band (ch.44+48), with other signal strength, and starts the active scan on each channel of the mode having the highest signal strength. Here, generally, this is why an access point on which wireless LAN connection is to be performed is the nearest one, and the nearest access point has strong simultaneous signal strength.

For example, when the signal strength of the 40 MHz band (ch.36&ch.40) is the highest, as illustrated in B3, the active scan is performed on each of ch.36 and ch.40. As a result of the active scan, an access point is detected and presented to the user. When the detected access point is not selected by the user, the active scan is performed on each channel in a frequency range having the highest signal strength next to that of the 40 MHz band (ch.36+40).

As described above, in the communication system 101, before the active scan of each of channels (frequency bands), that is, before execution of processing of logical information, the presence or absence of a radio signal and the signal strength of the radio signal are checked in a broadband frequency group (region) including a plurality of channels. In addition, the signal strengths are compared to each other, the active scan is performed in order of channel of the group having the strong signal strength.

As a result, the search for a wireless LAN access point is speeded up, so that, for example, the convenience of a device that performs the radio communication such as a high-function mobile phone, a tablet terminal, or a laptop personal computer is improved.

### [Operation in the Case of the 2.4 GHz Range]

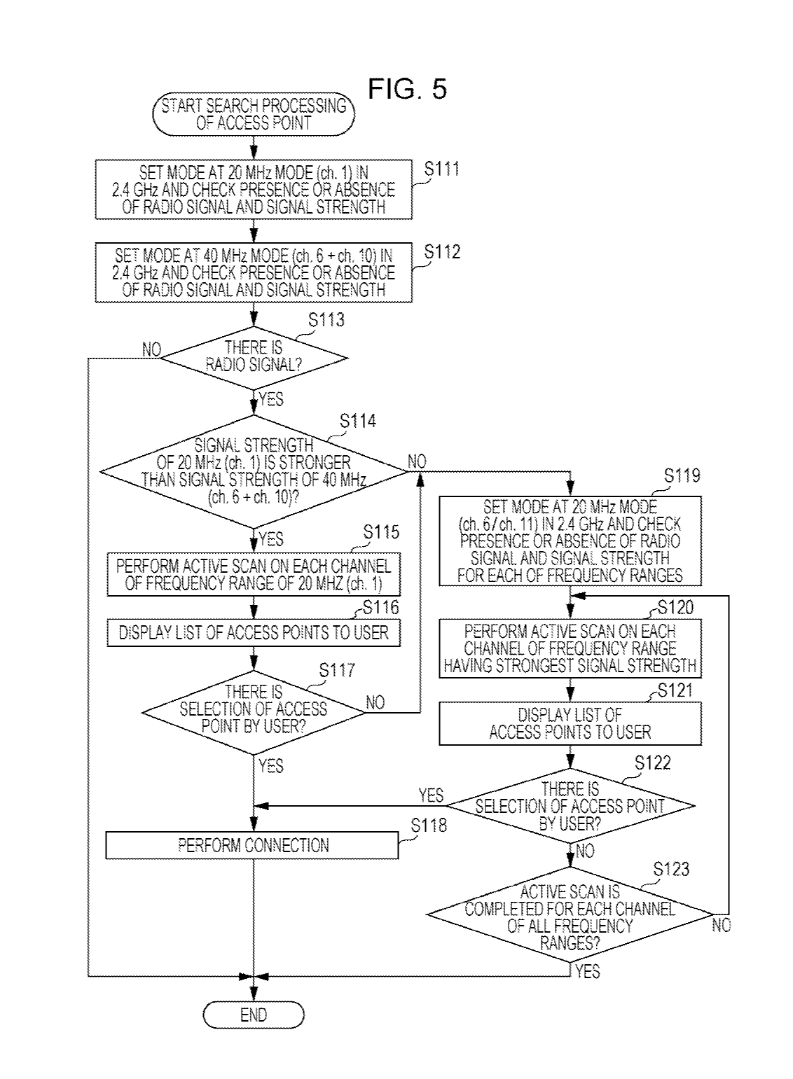

Searching processing for searching for an access point in the case of the 2.4 GHz range in the communication system 101 is described below with reference to the flowchart of FIG. 5.

In Step S111, the radio communication control unit 122 sets the mode of the frequency band of the radio communication module 121 to the 20 MHz mode (20 MHz band (ch.1)) in which ch.1 is set as the center in the 2.4 GHz. In addition, the radio communication control unit 122 checks the presence or absence of a radio signal and the signal strength of the radio signal in the set frequency range using the RF transmission/reception unit 131.

In Step S112, the radio communication control unit 122 sets the mode of the frequency band of the radio communication module 121 to the 40 MHz mode (40 MHz band (ch.6+ch.10)) in which ch.6 and ch.10 are set as the center in the 2.4 GHz. The radio communication control unit 122 checks the presence or absence of a radio signal and the signal strength of the radio signal in the set frequency range using the RF transmission/reception unit 131.

When the RF transmission/reception unit 131 receives a radio signal, the RF transmission/reception unit 131 supplies the received radio signal to the A/D conversion unit 132. The A/D conversion unit 132 converts the analogue radio signal that is supplied from the RF transmission/reception unit 131, into a digital signal, and supplies the converted digital signal to the radio communication control unit 122.

In Step S113, the radio communication control unit 122 determines whether or not there is a radio signal in the 20 MHz band (ch.1) and the 40 MHz band (CH.6+11) by referring to the digital signal that is supplied from the A/D conversion unit 132. In Step S113, when the radio communication control unit 122 determines that there is no radio signal, the searching processing for searching for an access point ends.

On the other hand, in Step S113, when the radio communication control unit 122 determines that there is a radio signal, the flow proceeds to Step S114.

In Step S114, the radio communication control unit 122 determines whether or not the signal strength in the 20 MHz band (ch.1) is higher than the signal strength in the 40 MHz band (CH.6+ch.11). In Step S114, when the radio communication control unit 122 determines that the signal strength in the 20 MHz band (ch.1) is higher than the signal strength in the 40 MHz band (CH.6+ch.11), the flow proceeds to Step S115.

In Step S115, the radio communication control unit 122 causes the MAC control unit 133 to perform the active scan on each channel of the 20 MHz band (ch.1). That is, the MAC control unit 133 transmits a probe request to each of channels (frequency bands) through the RF transmission/reception unit 131, and a radio access point that has received the probe request returns information regarding the access point.

For example, the active scan is started from the center frequency ch.1. After ch.1, the processing for ch.2 may be performed, and the processing for ch.3 may be performed.

When a radio access point is detected by the active scan, the MAC control unit 133 supplies information regarding the access point to the radio communication control unit 122. The information regarding the access point includes at least a display name of the access point and is supplied to the display control unit 124 through the control unit 123.

In Step S116, the display control unit 124 causes the display unit 125 to display a list of the access points, and presents the list to the user.

In practice, the processing in Step S115 and S116 is executed for each channel. That is, the list of the access points is presented to the user in Step S116 immediately after the scan on each of channels is completed in Step S115. As a result, the user can find a target access point as soon as possible.

When there is a target access point name on the list of the access points, which is displayed on the display unit 125, the user selects the access point by operating the operation input unit 126. The operation input unit 126 supplies a signal that corresponds to the operation of the user to the control unit 123.

In Step S117, the control unit 123 determines whether or not there is selection of the access point by the user by referring to the signal that is supplied from the operation input unit 126. In Step S117, when the control unit 123 determines that there is selection of the access point by the user, the control unit 123 supplies information regarding the access point that is selected by the user, to the radio communication control unit 122, and the flow proceeds to Step S118.

In Step S118, the radio communication control unit 122 causes the MAC control unit 133 to connect the access point that is selected by the user with the information processing device 112. After that, the searching processing for searching for an access point ends.

On the other hand, in Step S114, when the radio communication control unit 122 determines that the signal strength in the 40 MHz band (ch.6+ch.10) is higher than the signal strength in the 20 MHz band (ch.1), the flow proceeds to Step S119. In addition, in Step S117, when the control unit 123 determines that there is no selection of the access point by the user, the flow proceeds to Step S119.

In Step S119, the radio communication control unit 122 sets the mode of the frequency band of the radio communication module 121 to the 20 MHz band (CH.6) and the 20 MHz band (ch.11) in the 2.4 GHz. The radio communication control unit 122 checks the presence or absence of a radio signal and the signal strength of the radio signal using the RF transmission/reception unit 131 for each of the set frequency bands.

When the RF transmission/reception unit 131 receives a radio signal, the RF transmission/reception unit 131 supplies the received radio signal to the A/D conversion unit 132. The A/D conversion unit 132 converts the analogue radio signal that is supplied from the RF transmission/reception unit 131 into a digital signal, and supplies the converted digital signal to the radio communication control unit 122.

In Step S120, the radio communication control unit 122 compares the signal strengths and performs the active scan on each channel of a frequency range having the strong signal strength.

In the case of the 20 MHz band (CH.6), for example, the active scan is started from the center frequency ch.6. After ch.6, the processing may be executed in order of ch.4, ch.5, ch.7, and ch.8, and the processing may be executed in order of ch.5, ch.6, ch.4, and ch.8, and the order is not limited except for the scan for the center frequency.

Similarly, in the case of the 20 MHz band (CH.11), for example, the active scan is started from the center frequency ch.11. After ch.11, the processing may be executed in order of ch.9, ch.10, ch.12, and ch.13, and the processing may be executed in order of ch.10, ch.12, ch.9, and ch.13 and the order is not limited except for the scan for the center frequency.

When a radio access point is detected by the active scan, the MAC control unit 133 supplies information regarding the access point to the radio communication control unit 122. The information regarding the access point includes at least a display name of the access point and is supplied to the display control unit 124 through the control unit 123.

In Step S121, the display control unit 124 causes the display unit 125 to display a list of the access points and presents the list to the user.

In practice, the processing in Step S121 and S122 is basically similar to the processing in Step S115 and S116 and is executed for each channel. That is, in Step S122, the list of the access points is presented to the user immediately after the scan on each of channels is completed in Step S121. As a result, the user can find a target access point as soon as possible.

When there is a target access point name on the list of the access points, which is displayed on the display unit 125, the user selects the access point by operating the operation input unit 126. The operation input unit 126 supplies a signal that corresponds to the operation of the user, to the control unit 123.

In Step S122, the control unit 123 determines whether or not there is selection of the access point by the user by referring to the signal that is supplied from the operation input unit 126. In Step S122, when the control unit 123 determines that there is selection of the access point by the user, the control unit 123 supplies information regarding the access point that is selected by the user, to the radio communication control unit 122, and the flow proceeds to Step S118.

In Step S122, when the control unit 123 determines that there is no selection of the access point by the user, the flow proceeds to Step S123. In Step S123, the radio communication control unit 122 determines whether or not the active scan is completed for all of the frequency ranges.

In Step S123, when the radio communication control unit 122 determines that the active scan is not completed for all of the frequency ranges, the flow returns to Step S120, and the subsequent pieces of processing are repeated.

In Step S123, when the radio communication control unit 122 determines that the active scan is completed for all of the frequency range groups, the searching processing for searching for an access point ends.

With reference to the example of FIG. 5, an example is described in which processing for a subsequent frequency range (check of a signal strength or active scan) is executed when it is determined that there is no selection of an access point by the user after the list is presented to the user, however the embodiment is not limited to such an example. For example, a button, etc. that is used to display a list of the next access points is provided on a screen that displays the list, and processing for the next frequency range may be executed immediately after the user presses the button.

### [Operation in the Case of 5 GHz Range]

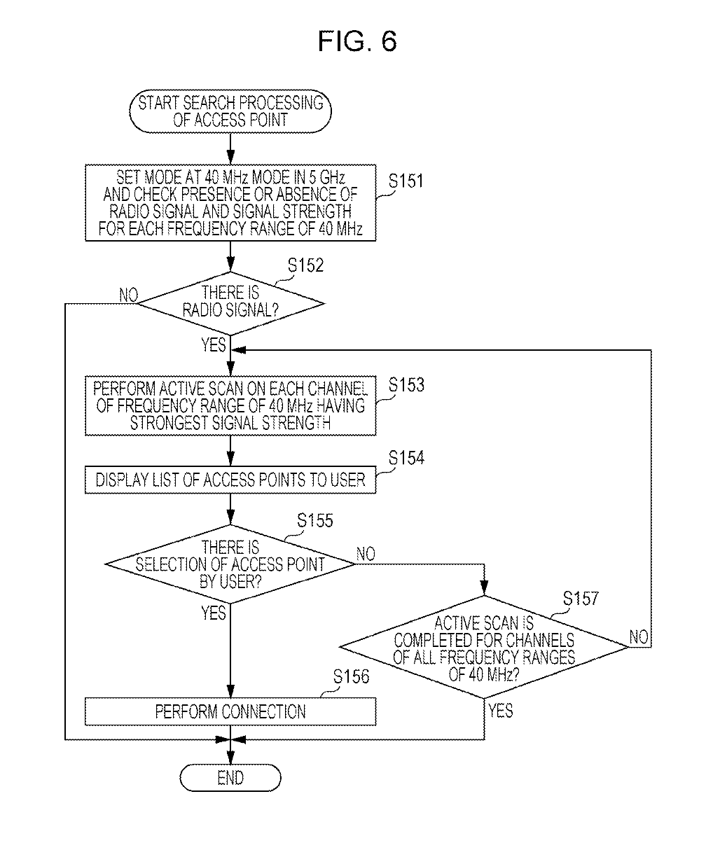

Searching processing for searching for an access point in the case of the 5 GHz range in the communication system 101 is described below with reference to the flowchart of FIG. 6.

In Step S151, the radio communication control unit 122 sets the mode of the frequency band of the radio communication module 121 to the 40 MHz mode in the 5 GHz, and checks the presence or absence of a radio signal and the signal strength of the radio signal using the RF transmission/reception unit 131 for each of the set frequency bands of 40 MHz.

When the RF transmission/reception unit 131 receives a radio signal, the RF transmission/reception unit 131 supplies the received radio signal to the A/D conversion unit 132. The A/D conversion unit 132 converts the analogue radio signal that is supplied from the RF transmission/reception unit 131 into a digital signal, and supplies the converted digital signal to the radio communication control unit 122.

In Step S152, the radio communication control unit 122 determines whether or not there is a radio signal in each of the frequency ranges by referring to the digital signal that is supplied from the A/D conversion unit 132. In Step S152, when the radio communication control unit 122 determines that there is no radio signal in all of the frequency ranges, the searching processing for searching for an access point ends.

On the other hand, in Step S152, when the radio communication control unit 122 determines that there is a radio signal in the frequency range, the flow proceeds to Step S153.

In Step S153, the radio communication control unit 122 compares the signal strengths of the frequency ranges, and performs the active scan on each channel of the frequency range having the strong signal strength. For example, in the 40 MHz mode in the 5 GHz, two channels are included in the frequency range of 40 MHz, and the active scan is performed on the two channels in order.

That is, the MAC control unit 133 transmits a probe request to each of channels (frequency bands) through the RF transmission/reception unit 131, and a radio access point, which has receive the probe request, gives back information regarding the access point.

When a radio access point is detected by the active scan, the MAC control unit 133 supplies information regarding the access point to the radio communication control unit 122. The information regarding the access point includes at least a display name of the access point and is supplied to the display control unit 124 through the control unit 123.

In Step S154, the display control unit 124 causes the display unit 125 to display a list of the access points and presents the list to the user.

In practice, the processing in Step S153 and S154 is basically similar to the processing in Step S115 and S116 of FIG. 5, and executed for each channel. That is, in Step S154, the list of the access points is presented to the user immediately after the scan on each of channels is completed in Step S153. As a result, the user can find a target access point as soon as possible.

When there is a target access point name on the list of the access points, which is displayed on the display unit 125, the user selects the access point by operating the operation input unit 126. The operation input unit 126 supplies a signal that corresponds to the operation of the user, to the control unit 123.

In Step S155, the control unit 123 determines whether or not there is selection of the access point by the user by referring to the signal that is supplied from the operation input unit 126. In Step S155, when the control unit 123 determines that there is selection of the access point by the user, the control unit 123 supplies information regarding the access point that is selected by the user, to the radio communication control unit 122, and the flow proceeds to Step S156.

In Step S156, the radio communication control unit 122 causes the MAC control unit 133 to connect the access point that is selected by the user with the information processing device 112. After that, the searching processing for searching for an access point ends.

In Step S155, when the control unit 123 determines that there is no selection of the access point by the user, the flow proceeds to Step S157. In Step S157, the radio communication control unit 122 determines whether or not the active scan is completed for the channels of all of the frequency ranges of the 40 MHz.

In Step S123, when the radio communication control unit 122 determines that the active scan is not completed yet for channels of all of the frequency ranges, the flow returns to Step S153, and the subsequent pieces of processing are repeated.

In Step S123, when the radio communication control unit 122 determines that the active scan is completed for channels of all of the frequency ranges, the searching processing for searching for an access point ends.

As described above, in the communication system 101, before processing of logical information is executed on each channel (frequency band), the presence or absence of a radio signal and the signal strength of the radio signal are checked in a broadband frequency group (region) including a plurality of channels. In addition, the signal strengths are compared to each other, the active scan is performed in order of channel of the group having the highest signal strength.

As a result, the search for a wireless LAN access point is speeded up, so that, for example, the convenience of the device that performs the radio communication such as the high-function mobile phone, the tablet terminal, or the laptop personal computer is improved.

### [Another Configuration of the Communication System According to the Embodiment of the Present Technology]

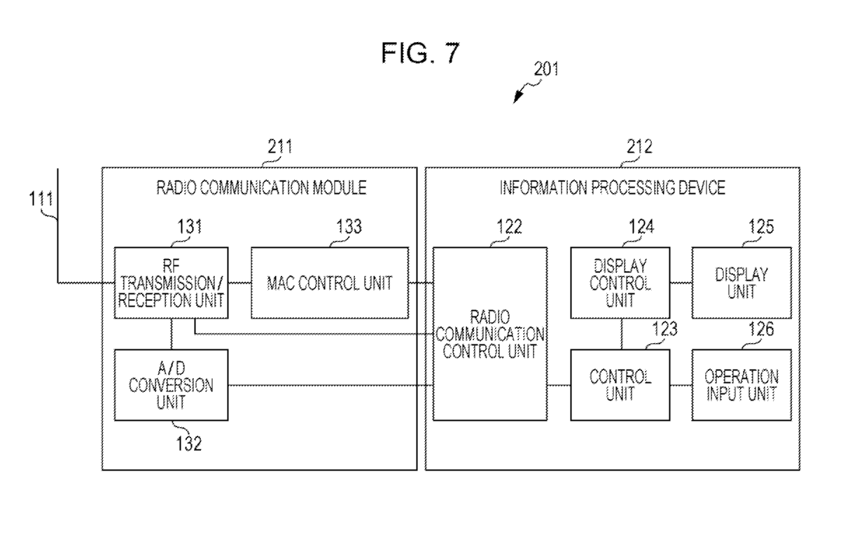

FIG. 7 is another configuration example of the communication system according to the embodiment of the present technology.

In the example of FIG. 7, a communication system 201 includes the antenna 111, a radio communication module 211, and an information processing device 212.

The radio communication module 211 is different from the radio communication module 121 illustrated in FIG. 1 in that the radio communication module 211 is removably provided outside the information processing device 212. The radio communication module 211 is common with the radio communication module 121 illustrated in FIG. 1 in that the RF transmission/reception unit 131, the A/D conversion unit 132, and the MAC control unit 133 are included in the configuration.

The information processing device 212 is different from the information processing device 112 illustrated in FIG. 1 in that the radio communication module 121 is removed from the configuration. The information processing device 212 is common with the information processing device 112 illustrated in FIG. 1 in that the radio communication control unit 122, the control unit 123, the display control unit 124, the display unit 125, and the operation input unit 126 are included in the configuration.

That is, in the communication system 101 illustrated in FIG. 1, the radio communication module 121 is built into the information processing device 112, and in the communication system 201 illustrated in FIG. 7, the radio communication module 211 is removably provided outside the information processing device 212.

Thus, the communication system 201 illustrated in FIG. 7 executes processing that is basically similar to the processing of the communication system 101 illustrated in FIG. 1, and the description is omitted to avoid the repetition.

As described above, in the communication system 201, the radio communication module 211 is provided outside the information processing device 212. Even in the communication system 201 that is configured as described above, similar to the communication system 101 illustrated in FIG. 1, before the active scan on the each channel (frequency band) is performed, the presence or absence of a radio signal and the signal strength of the radio signal are checked in a broadband frequency group (region) including a plurality of channels. In addition, the signal strengths are compared to each other, the active scan is started from a channel of the group having the strong signal strength.

As a result, search for a wireless LAN access point is speeded up, so that, for example, the convenience of the device that performs the radio communication such as the high-function mobile phone, the tablet terminal, and the laptop personal computer is improved.

### [Another Configuration of the Communication System According to the Embodiment of the Present Technology]

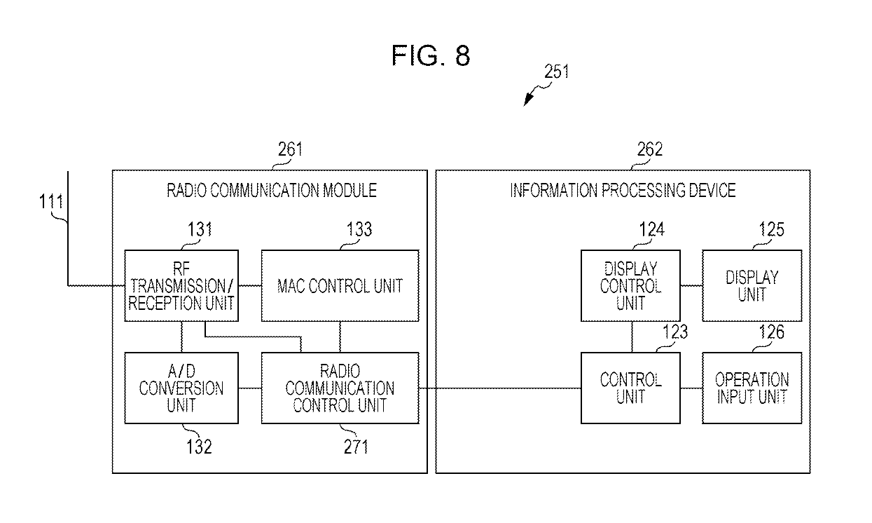

FIG. 8 is a diagram illustrating another configuration example of the communication system according to the embodiment of the present technology.

In the example of FIG. 8, a communication system 251 includes the antenna 111, a radio communication module 261, and an information processing device 262.

The radio communication module 261 is different from the radio communication module 211 illustrated in FIG. 7 in that a radio communication control unit 271 is added to the radio communication module 261. The radio communication module 261 is common with the radio communication module 211 illustrated in FIG. 7 in that the RF transmission/reception unit 131, A/D conversion unit 132, and the MAC control unit 133 are included in the configuration.

The information processing device 262 is different from the information processing device 212 illustrated in FIG. 7 in that the radio communication control unit 122 is removed from the configuration. The information processing device 262 is common with the information processing device 212 illustrated in FIG. 7 in that the control unit 123, the display control unit 124, the display unit 125, and the operation input unit 126 are included in the configuration.

The radio communication control unit 271 is provided in a location that is different from the location of the radio communication control unit 122 in FIGS. 1 and 7, however the radio communication control unit 271 executes processing that is basically similar to the processing of the radio communication control unit 122 in FIGS. 1 and 7.

That is, in the communication system 201 illustrated in FIG. 7, the radio communication control unit 122 is provided on the information processing device 212 side, and in the communication system 251 in FIG. 8, the radio communication control unit 271 is provided on the radio communication module 261 side.

Thus, in the communication system 251 in FIG. 8, a processing load is applied on the radio communication module 261 side, the processing to be executed is basically similar to the processing of the communication system 201 illustrated in FIG. 7 (that is, the communication system 101 illustrated in FIG. 1), and the description is omitted to avoid the repetition.

As described above, in the communication system 251, the radio communication module 261 is provided outside the information processing device 262, and the radio communication control unit 271 is provided on the radio communication module 261 side. Even in the communication system 251 that is configured as described above, similar to the communication system 101 illustrated in FIG. 1, before the active scan on each channel (frequency band) is performed, the presence or absence of a radio signal and the signal strength of the radio signal are checked in a broadband frequency group (region) including a plurality of channels. In addition, the signal strengths are compared to each other, and the active scan is started from a channel of the group having the strong signal strength.

As a result, search for a wireless LAN access point is speeded up, so that, for example, the convenience of the device that performs the radio communication such as the high-function mobile phone, the tablet terminal, and the laptop personal computer is improved.

### [Another Configuration of the Communication System According to the Embodiment of the Present Technology]

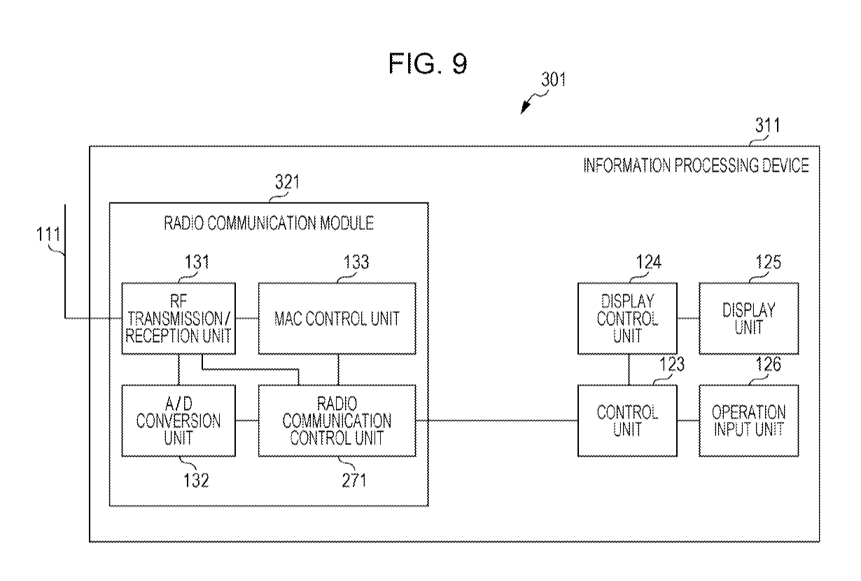

FIG. 9 is a diagram illustrating another configuration example of the communication system according to the embodiment of the present technology.

In the example of FIG. 9, a communication system 301 includes the antenna 111 and an information processing device 311.

The information processing device 311 is different from the information processing device 112 illustrated in FIG. 1 in that the radio communication module 121 is replaced with a radio communication module 321 and the radio communication control unit 122 is removed from the configuration. The information processing device 311 is common with the information processing device 112 illustrated in FIG. 1 in that the control unit 123, the display control unit 124, the display unit 125, and the operation input unit 126 are included in the configuration.

The radio communication module 321 is different from the radio communication module 261 in FIG. 8 in that the radio communication module 321 is built into the information processing device 311.

In addition, that is, the radio communication module 321 is different from the radio communication module 121 illustrated in FIG. 1 in that the radio communication control unit 271 in FIG. 8 is added to the radio communication module 321. The radio communication module 321 is common with the radio communication module 121 illustrated in FIG. 1 in that the RF transmission/reception unit 131, the A/D conversion unit 132, and the MAC control unit 133 are included in the configuration.

Similar to the radio communication control unit 271 in FIG. 8, the radio communication control unit 271 is provided in a location that is different from the location of the radio communication control unit 122 in FIGS. 1 and 7, and executes processing that is basically similar to the processing of the radio communication control unit 122.

That is, in the communication system 101 illustrated in FIG. 1, the radio communication control unit 122 is provided on the information processing device 112 side, and in the communication system 301 in FIG. 9, the radio communication control unit 271 is provided in the radio communication module 321.

Thus, in the communication system 301 in FIG. 9, a processing load is applied on the radio communication module 321 side, and the processing to be executed is basically similar to the processing of the communication system 101 illustrated in FIG. 1, and the description is omitted to avoid the repetition.

As described above, in the communication system 301, the radio communication control unit 271 is provided on the side of the radio communication module 321 that is built into the information processing device 311. Even in the communication system 301 that is configured as described above, similar to the communication system 101 illustrated in FIG. 1, before the active scan on each channel (frequency band) is performed, the presence or absence of a radio signal and the signal strength of the radio signal are checked in a broadband frequency group (region) including a plurality of channels. In addition, the signal strengths are compared to each other, and the active scan is started from a channel of the group having the highest signal strength.

As a result, search for a wireless LAN access point is speeded up, so that, for example, the convenience of the device that performs the radio communication such as the high-function mobile phone, the tablet terminal, and the laptop personal computer is improved.

In the above description, the example in the infrastructure mode is described in which the communication is performed with a radio access point as a communication target, however a range according to the embodiment of the present technology is not limited to such an example. That is, the present technology can be applied to a case of communication in an ad-hoc mode in which the communication is performed with a client as a communication target (that is, between terminals).

The above-described series of pieces of processing can be executed by hardware and can be also executed by software. When the series of pieces of processing is executed by software, a program that configures the software is installed in a computer. Here, the computer includes a computer that is integrated in dedicated hardware and a general-purpose personal computer that can executes various functions by installing various programs.

### [Configuration Example of the Computer]

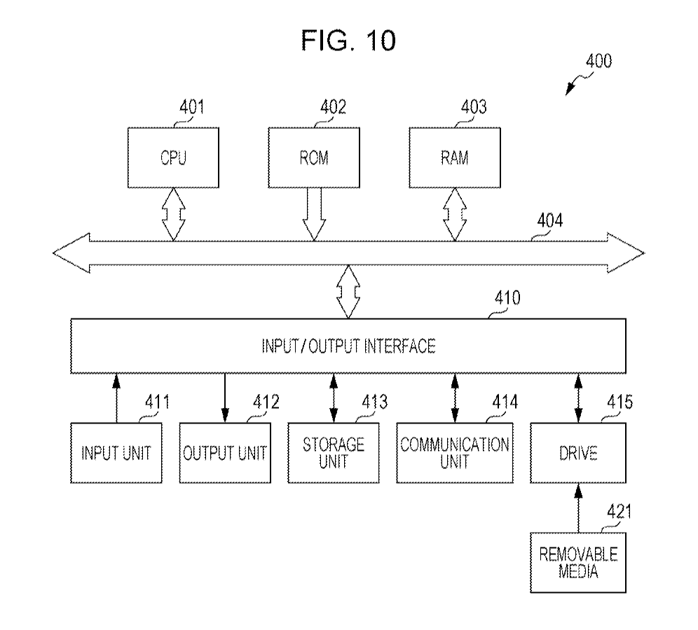

FIG. 10 illustrates a hardware configuration example of a computer that executes the above-described series of pieces of processing by a program.

In a computer 400, a central processing unit (CPU) 401, a read only memory (ROM) 402, and a random access memory (RAM) 403 are connected with each other through a bus 404.

To the bus 404, an input/output interface 410 is connected. To the input/output interface 410, an input unit 411, an output unit 412, a storage unit 413, a communication unit 414, and a drive 415 are connected.

The input unit 411 is constituted by a keyboard, a mouse, a microphone, etc. The output unit 412 is constituted by a display, a speaker, etc. The storage unit 413 is constituted by a hardware disk, a nonvolatile memory, etc. The communication unit 414 is constituted by a network interface, etc. The drive 415 drives a removable medium 421 such as a magnetic disk, an optical disk, a magneto-optical disk, or a semiconductor memory.

In the computer that is configured as described above, for example, when the CPU 401 loads a program that is stored in the storage unit 413, to the RAM 403 through the input/output interface 410 and the bus 404 and executes the program, the above-described series of pieces of processing is executed.

For example, the program that is executed by the computer (CPU 401) can be provided so as to be recorded in the removable medium 421 as a package medium, etc. In addition, the program can be provided through a wired or wireless transmission medium such as a local area network, the Internet, and digital satellite broadcasting.

In the computer, the program can be installed in the storage unit 413 through the input/output interface 410 by mounting the removable medium 421 on the drive 415. In addition, the program is received at the communication unit 414 through the wired or wireless transmission medium, and can be installed in the storage unit 413. In addition, the program can be installed in the ROM 402 and the storage unit 413 in advance.

The program that is executed by the computer may be a program the pieces of processing of which are executed in time series in the order that is described herein, and may be a program the pieces of processing of which are executed in parallel or at desired timing such as timing at which a call is made.

In the present specification, “Steps” in which the above-described series of pieces of processing is described includes pieces of processing that are not necessarily executed in time series but executed in parallel or separately, in addition to the pieces of processing that are executed in time series in the described order.

In addition, embodiments of the present disclosure are not limited to the above-described embodiments, and various changes can be made without departing from the scope of the present disclosure.

In addition, Steps that are described with reference to the above-described flowchart can be executed so as to be distributed to a plurality of devices in addition to execution by a single device.

In addition, when a plurality of pieces of processing are included in single Step, the plurality of pieces of processing that are included in such Step can be executed so as to be distributed to a plurality of devices in addition to execution by a single device.

In addition, the configuration that is described as a single device (or processing unit) in the above description may be divided and configured as a plurality of devices (or processing units). On the contrary, the configuration that is described as a plurality of devices (or processing units) in the above description may be aggregated and configured as a single device (or processing unit). In addition, a configuration element other than the above-described configuration elements may be added to the configuration of the devices (or the processing units). In addition, as long as a configuration or an operation of the whole system is substantially the same, a part of a configuration of a certain device (or processing unit) may be included in a configuration of another device (or another processing unit). That is, the present technology is not limited to the above-described embodiments, and various changes can be made without departing from the scope of the present technology.

As described above, the desirable embodiments of the present disclosure are described in detail with reference to the accompanying drawings, and the present disclosure is not limited to such examples. For those skills in the art that belong to the present disclosure, it will be apparent that various modifications and alterations may be conceived in the scope of the technical idea described in the claims, and it will be naturally understood that the modifications and alterations also belong to the technical scope of the present disclosure.

The present technology can also employ the following configuration.

(1) A communication device including:

a signal strength check unit that checks the signal strength of a radio signal using a broad radio frequency range; and

a communication target detection unit that detects a communication target in descending order of the signal strength of the radio signal, which is checked by the signal strength check unit, for each frequency band that is included in the broad radio frequency range.

(2) The communication device according to (1), wherein

the signal strength check unit checks the signal strength of the radio signal using the broad radio frequency range, and checks the signal strength of the radio signal using a radio frequency range that is narrower than the broad radio frequency range, in the broad radio frequency range in descending order of checked signal strength of the radio signal, and

the communication target detection unit detects the communication target for each frequency that is included in the narrower radio frequency range in descending order of the signal strength of the radio signal, which is checked by the signal strength check unit.

(3) The communication device according to (1) or (2), wherein,

the communication target detection unit detects the communication target from a frequency band that is a center of the radio frequency range, out of frequency bands that are included in the broad radio frequency range.

(4) The communication device according to any one of (1) to (3), wherein

the communication device is constituted by a module.

(5) The communication device according to any one of (1) to (3), wherein

the communication device is constituted by an integrated device.

(6) The communication device according to any one of (1) to (5), further including:

a display control unit that controls display of the communication target that is detected by the communication target detection unit each time the communication target detection unit terminates the detection of the communication target for each of the frequency bands.

(7) The communication device according to any one of (1) to (6), wherein

the communication target is an access point.

(8) A communication method including;

checking the signal strength of a radio signal using a broad radio frequency range by a communication device; and

detecting a communication target in descending order of checked signal strength of the radio signal, for each frequency band that is included in the broad radio frequency range.

The present disclosure contains subject matter related to that disclosed in Japanese Priority Patent Application JP 2012-182452 filed in the Japan Patent Office on Aug. 21, 2012, the entire contents of which are hereby incorporated by reference.

What is claimed is:

1. A communication device comprising:
a signal strength check unit configured to check the signal strength of a radio signal using a broad radio frequency range; and
a communication target detection unit configured to detect a communication target in descending order of the signal strength of the radio signal, which is checked by the signal strength check unit, for each frequency band that is included in the broad radio frequency range.

2. The communication device according to claim 1, wherein
the signal strength check unit is configured to check the signal strength of the radio signal using the broad radio frequency range, and to check the signal strength of the radio signal using a radio frequency range that is narrower than the broad radio frequency range, in the broad radio frequency range in descending order of checked signal strength of the radio signal, and
the communication target detection unit is configured to detect the communication target for each frequency that is included in the narrower radio frequency range in descending order of the signal strength of the radio signal, which is checked by the signal strength check unit.

3. The communication device according to claim 1, wherein
the communication target detection unit is configured to detect the communication target from a frequency band that is a center of the broad radio frequency range, out of frequency bands that are included in the broad radio frequency range.

4. The communication device according to claim 1, wherein
the communication device is constituted by a module.

5. The communication device according to claim 1, wherein
the communication device is constituted by an integrated device.

6. The communication device according to claim 1, further comprising:
a display control unit configured to control display of the communication target that is detected by the communication target detection unit each time the communication target detection unit terminates the detection of the communication target for each of the frequency bands.

7. The communication device according to claim 1, wherein
the communication target is an access point.

8. A communication method comprising;
checking the signal strength of a radio signal using a broad radio frequency range by a communication device; and
detecting a communication target in descending order of checked signal strength of the radio signal, for each frequency band that is included in the broad radio frequency range.
